(19) United States
(12) Patent Application Publication
(10) Pub. No.: US 2005/0111030 A1
(43) Pub. Date: May 26, 2005

(54) Hard copy imaging systems, print server systems, and print server connectivity methods

(76) Inventors: Alan C. Berkema, Granite Bay, CA (US); Mark W. Fidler, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/723,277

(22) Filed: Nov. 25, 2003

(51) Int. Cl. G06F 15/00

(52) U.S. Cl. 358/1.15

(57) ABSTRACT

Aspects of the invention relate to hard copy imaging systems, print server systems, and print server connectivity methods. In one aspect, a hard copy imaging system includes a first communications network configured to operate in a first communication link format, a second communications network configured to operate in a second communication link format, a plurality of hard imaging devices communicatively coupled to the first communications network, and an external device communicatively coupled to the second communications network, the external device is configured to forward a print request to at least one of the plurality of hard imaging devices for processing. A print server is communicatively coupled to a plurality of hard imaging devices via the first communications network, and to the external device via the second communications network. The print server is configured to receive a print request from the external device in the second communication link format and generate a translated print request in the first communication link format for processing by at least one of the plurality of hard imaging devices. The print server is further configured to generate and communicate a signal to the external device, the signal being indicative of individual hard imaging devices among the plurality of hard imaging devices that are supported by the print server even if the plurality of hard imaging devices are not configured to support the second communication link format. Print server connectivity methods are also provided.

### FIELD OF THE INVENTION

Aspects of the invention relate to hard copy imaging systems, print server systems, and print server connectivity methods.

### BACKGROUND OF THE INVENTION

Enabling a user to employ printer services available over a network involves a complex set of tasks. Initial set-up in current network environments often requires creation and appropriate linking of print queues, printer objects and print servers. In order to forward a print job for processing, a client processor usually directs the print job to a network queue, a print server processes the job from the queue and then sends it to a printer for printing or other appropriate processing tasks. In such an environment, troubleshooting can be both difficult and time-consuming.

Certain printers may include print server cards that enable connection of a printer to a network without requiring a connected host computer. Such printer server cards include the “JetDirect” card and software, (JetDirect is a trademark of the Assignee of this application). A JetDirect print server card enables a printer to be connected to a network and to be used by multiple client processors. Upon being so connected, the JetDirect card and software causes transmission of a “Service Advertising Protocol” (SAP) that is an advertisement of the printer's availability. If the network to which the printer is connected is running in accordance with the “NetWare” network protocol or similar Network Operating Systems (NetWare is a trademark of the Novell Corporation, San Jose, Calif.), the network is controlled by a server which includes a database (i.e. called the “bindery”) for receiving and storing SAPs from newly connected printers.

Each SAP includes a limited amount of information that defines the originating printer, its network address, and some of its capabilities. A user requiring access to a printer calls a utility program running on the user's client processor. That utility program, e.g., the JetAdmin product, selects a mode to find SAPs stored in a network server. After being accessed, the SAP information is downloaded to the client processor and is displayed to the user. The user then selects an appropriate printer and requests that a print queue be set up in the network server to enable interconnection between the client processor and the selected printer. Specifying the print queue and other data may be required to be inputted, by a user, before appropriate interconnection of client and server devices can be accomplished. Since establishment of a network printer interconnection requires a level of sophistication on the part of the user, less sophisticated users may often experience difficulties in establishing a proper printer/client connection.

Furthermore, traditional print servers such as the Hewlett Packard JetDirect 310x connect a printer to the print server using a direct connection such as, for example, a Universal Serial Bus (USB) link. IEEE 1284 parallel port or RS 232 serial port connection have also been used for direct connection of printers to print servers. Input to the print server has typically been a LAN connection, which may be a wired or a wireless connection as shown in FIG. 1.

FIG. 1 shows a typical print server system 100. Print server system 100 includes a print server 102 directly connected to a printer 104 via a communication medium 106. Input to the print server 102 may be received via a local area network (LAN) connection 108. Thus, an external print job or request is received by the print server 102 via a local area network (LAN) connection 108. The print server 102 passes the external print request to printer 104 for further processing and printing. Although legacy parallel port print servers may be attached to multiple printers, the number of printers served may be limited with this approach.

The print server 102 may be configured to receive print job requests from varied sources via various communication links. These links may be served by a variety of network communication protocols. However, if a print job is received by the print sever 102 via a new communication link operating with a new network communication protocol to which the print server 102 is not configured, then a user may have to purchase a new print server that is configured to operate with the new network communication protocol, or forego the new link technology.

Traditional print servers can be popular for wired LANs, such as, for example, IEEE 802.3 and 802.3u, 10/100T, when a new link technology (e.g., 802.11, Bluetooth®) evolves, a customer may have to choose between the two or purchase a new additional print server for individual printers. In the case of new installation having 802.11 wireless connections, purchasing a single 802.11 print server may be a viable option. However, it still does not address printing with other new technologies, such as, for example, Bluetooth.

Thus, there is a need to solve the above-identified problems encountered by the prior approaches.

### SUMMARY OF THE INVENTION

Aspects of the invention overcome the above-identified drawbacks by enabling a new print server to connect an existing network of printers, either wired or wireless, to a new communication link technology without the need to purchase an additional print server for individual printers. At least some embodiments of the invention relate to hard copy imaging systems, print server systems, and print server connectivity methods.

In some embodiments, a hard copy imaging system having a first communications network configured to operate in a first communication link format, a second communications network configured to operate in a second communication link format, a plurality of hard imaging devices communicatively coupled to the first communications network, an external device communicatively coupled to the second communications network, the external device is configured to forward a print request to at least one of the plurality of hard imaging devices for processing. A print server is communicatively coupled to a plurality of hard imaging devices via the first communications network, and to an external device via the second communications network. The print server is configured to receive a print request from the external device in the second communication link format and automatically generate a translated print request in the first communication link format for processing by at least one of the plurality of hard imaging devices. The print server is further configured to automatically generate and communicate a signal to the external device, the signal being indicative of individual hard imaging devices among the plurality of hard imaging devices that are supported by the print server even if the plurality of hard imaging devices are not configured to support the second communication link format.

Other print server systems, methods, and computer-readable media are provided.

### DESCRIPTION OF THE DRAWINGS

FIG. 1 is a block diagram of a typical print server system.

FIGS. 2-4 are block diagram schematics of a print server system in accordance with various embodiments of the invention.

FIG. 5 is a functional block diagram of a print server in accordance with various embodiments of the invention.

FIG. 6 is a detailed schematic of a print server in accordance with various embodiments of the invention.

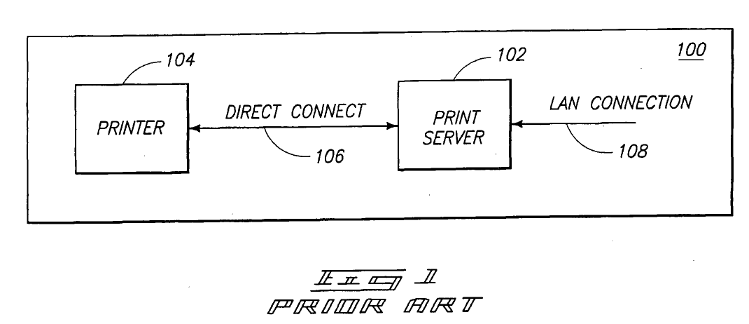

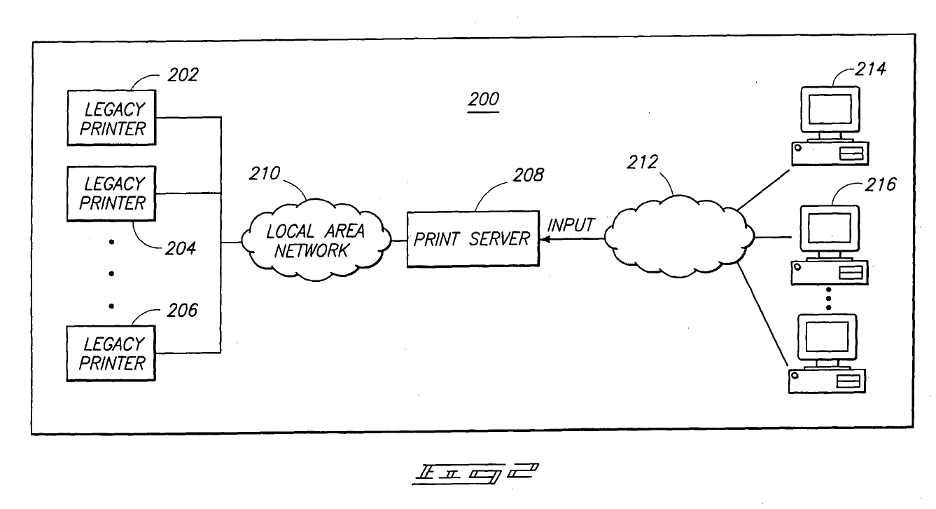

### DETAILED DESCRIPTION OF THE INVENTION

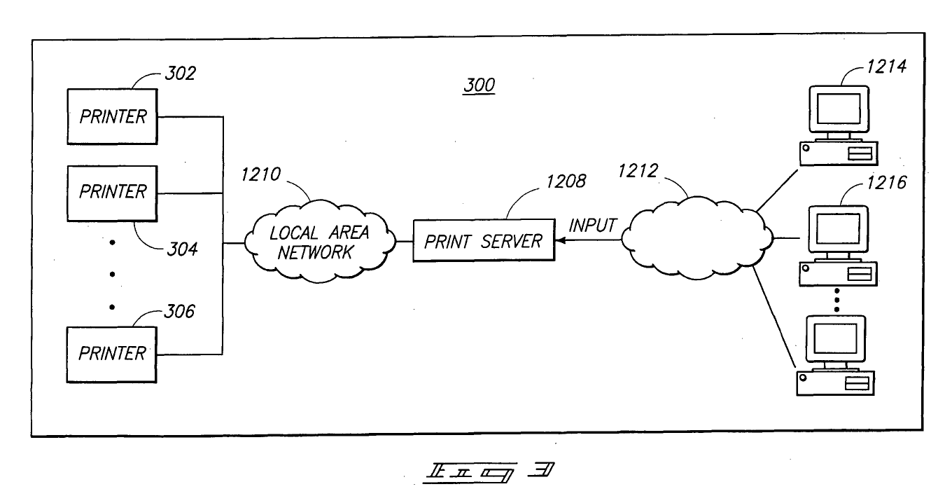

FIG. 2 shows a print server system schematic 200 in accordance with exemplary embodiments of the present invention. The print server system 200 includes a plurality of printers 202, 204, 206, a print server 208, communications networks 210, 212, and external devices 214, 216. In one arrangement, at least some of devices 202, 204, 206, 208, 214, and 216 may be provided at locations physically separated from one another.

The printers 202, 204, and 206 may be configured to form hard images. Such printers and printers identified in various embodiments may be alternatively referred as “hard imaging devices.” Hard images are images physically rendered upon output media, such as sheet paper, roll paper, envelopes, transparencies, labels, etc. The printers 202, 204, and 206 may be implemented as laser printers, inkjet printers, impact printers, copiers, facsimile devices, multiple function peripheral (MFP) devices, or otherwise arranged to form hard images. The printers 202, 204, and 206 may each have the same or configurations that are different from other printers, in a given implementation of system 200. Printers 202, 204, and 206 connected to the communications network 210 are merely exemplary. It will be understood that more or fewer number of printers may be coupled to the communications network 210.

The print server 208 (e.g., new printer server level 1) is configured to receive and process requests from one or more external devices 214, 216. The print server 208 forwards the received requests to one or more printers 202, 204, 206 for further processing (e.g., printing) via the communications network 210. The print server 208 may be configured to support multiple discovery techniques such as, for example, Bluetooth Service Discovery protocol or Universal Plug and Play (UPnP) Simple Service Discovery protocol, and advertise the printers it supports. A user of the external devices 214, 216 may select a printer among printers supported by the print server 208 and submit a print request to the print server 208 via the communication network 212.

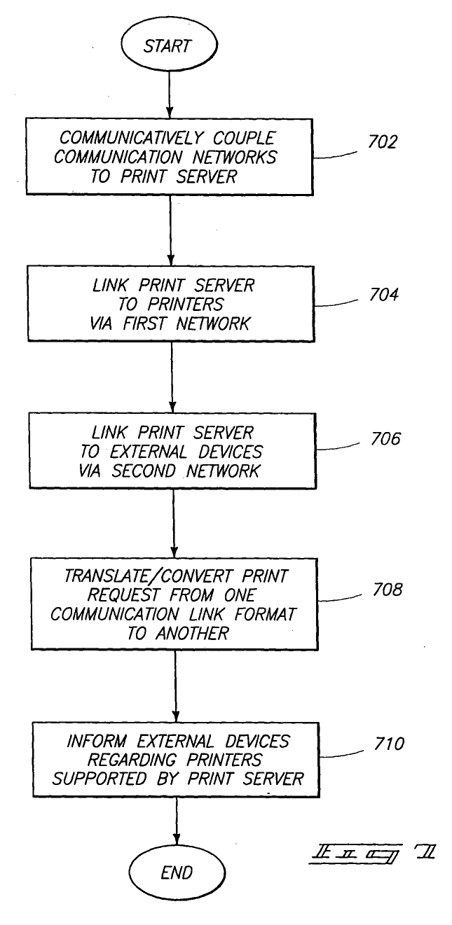

Such advertising by the print server 208 may include sending information from the print server 208 to the external devices 214, 216 regarding printers supported by the print server 208. Further, such advertising may be performed by the print server 208 even if individual printers that are communicatively coupled to the print server 208 are incapable of processing a request directly received by such printers from one or more of the external devices 214, 216. For example, the print server 208 may advertise that it supports UPnP or Bluetooth protocols though the printers 202, 204, and 206 are not configured to support such protocols. In such cases, the print server 208 is configured to receive a print request from the external devices 214, 216 and translate the received request into a format (e.g., communication link format) compatible with the printers 202, 204, 206. Further details regarding the print server 208 are described below with reference to FIG. 6.

The communications network 210 is configured to communicatively couple the printers 202, 204, 206 to the print server 208. For example, the communications network 210 may be a local area network (LAN), a wide area network (WAN), or other network configuration configured to communicate requests (e.g., print processing requests) from the print server 208 to the printers 202, 204, and 206, respectively.

The communications network 212 is configured to communicatively couple the external devices 214, 216 to the print server 208. In one case, the communications network 212 may be a different network (e.g., network architecture) or a network having a different link technology (e.g., communication link technology) when compared to the communications network 210. For example, the communications network 212 may be provided with network architecture to accommodate Bluetooth communications protocol, or 802.11 communication protocol. The communications networks 210 and 212 may be individually configured in any suitable manner to provide communication of electronic data, programming or other information between communicatively coupled devices. In another case, architecture or communication link format of the communications network 212 may be configured to be similar to that of the communications network 210. For example, the communications networks 210 and 212 may be configured to have similar communication link formats but with differing communication protocol layers.

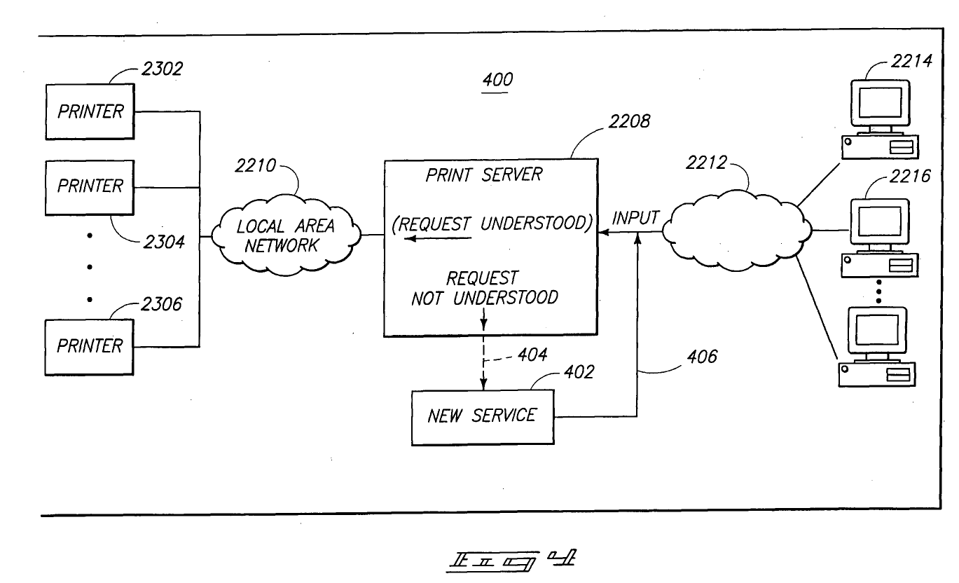

FIG. 3 is a schematic of a print server system 300 in accordance with another embodiment of the invention, wherein elements like those illustrated in FIG. 2 are identified using like reference numerals, but with a prefix “1” added. The system 300 includes printers 302, 304, and 306, a print server 1208, communications networks 1210, 1212, and external devices 1214, 1216.

The printers 302, 304, and 306 may be configured to form hard images and have some functions that are common with the printers 202, 204, and 206 described above with reference to FIG. 2. However, the printers 302, 304, and 306 may be configured to have simple architectural configurations wherein complex architecture (e.g., hardware and software) that may be required to enable processing of external print requests is made resident on the print server 1208.

The print server 1208 may be configured to be similar to that of the print server 208 but with additional features as described below. By moving select printer architecture to the print sever 1208, architectural complexity (e.g., both hardware and software) of the printers 302, 304, and 306 is reduced thereby rendering such printers to have simple architecture. For example, printers 302, 304, and 306 may be configured to operate using a single printer protocol, and intelligence (e.g., architecture) to receive external print requests (e.g., from devices 1214 and 1216) in varied communication link formats is made resident on the print server 1208. Thus, translation of external print requests from one communication link format to another, and network protocol tasks previously performed by printers 202, 204, 206 (FIG. 2), are now performed by the print server 1208. The translated requests are sent by the print server 1208 to a select printer among printers 302, 304, and 306 for further processing of print requests. The print server 1208 is also capable of supporting existing traditional print servers in order to enable a facility housing such printers and the print server to migrate, over a period of time, printers located within the facility.

Details regarding the communications networks 1210 and 1212, and the external devices 1214 and 1216 were set forth above with reference to the embodiment of FIG. 2, and therefore will not be repeated.

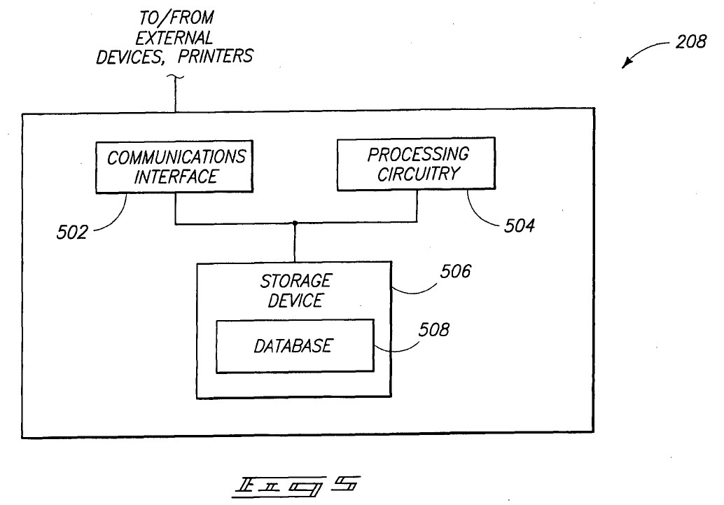

FIG. 4 is a schematic of a print server system 400 in accordance with yet another embodiment of the invention, wherein elements like those illustrated in FIGS. 2 and 3 are identified using like reference numerals, but with a prefix “2” added.

The print server system 400 includes printers 2302, 2304, and 2306, print server 2308, communications networks 2210, 2212, and external devices 2214, 2216, details of which have been described above with reference to FIGS. 2-3, and therefore will not be repeated. The system 400 also includes an external service 402 that is communicatively coupled to the print server 2208. In addition to the functionality described at FIGS. 2-3, the print server 2208 includes additional functionalities to process requests received, via the communications network 2212, from the external devices 2214 and 2216, as described below.

If a print request received from an external device (e.g., 2214 or 2216) is in a format that is understood by the print server 2208, then such a request is processed by the print server 2208. Processing of the print request may include translating the print request from a communication format or technology link format (e.g., compatible with communication network 2212 and external devices 2214, 2216) into another communication format or technology link format (e.g., compatible with communication network 2210 and printers 2302, 2304, 2306). Processing of the print request further includes forwarding the processed request to a select printer among printers 2302, 2304, or 2306 for further processing (e.g., printing) the request.

If a print request received from an external device (e.g., 2214, or 2216) is not understood by the print server 2208, then such request is forwarded by the print server 2208 to the external service 402 for further processing. The external service may be a part of the print server 2208 or an additional component on the network (e.g., 2212 or 2210). In one example, external service 402 may be configured to convert the print request that is not understood by the print server 2208 into a format that is compatible with the print server 2208. Such converted request is forwarded to the print server 2208 for processing as described above. In another example, the external service 402 may be configured to return the request back to sender (e.g., external device such as devices 2214, 2216 responsible for originating the request) with an indication that the request could not be processed by the print server 2208.

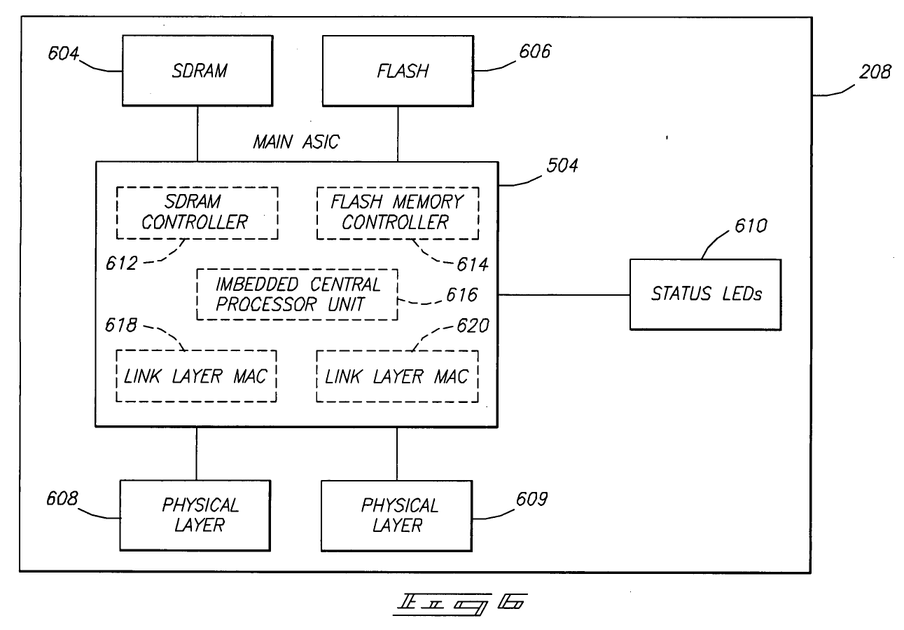

FIG. 5 is an exemplary functional block diagram of a print server in accordance with various embodiments of the invention. Print server 208 includes a communications interface 502, a processing circuitry 504, and a storage device 506 having a database 508.

The communications interface 502 is configured to communicate electronic data externally of the print server 208, for example, with respect to the communications networks 210 and 212. In one embodiment, the interface 502 is arranged to provide input/output communications with respect to external devices (e.g., 1214, 1216) and printers (e.g., 202, 204, and 206). The interface 502 may comprise a parallel port, USB port, EIO slot, network interface card (e.g., JetDirect™), IEEE 1394 connector, and/or other appropriate configuration capable of communicating electronic data.

The processing circuitry 504 is configured to process data (e.g., translation of information in one communication link format or technological link format into another communication format or technological link format) and forwarding of the translated requests to select printers (e.g., printers 202, 204, 206, or 302, 304, 306) for further processing. The processing circuitry 504 may also be configured to forward external print requests that are not understood by the print server 208 to service 402 (FIG. 4) for further processing (e.g., conversion from one format to another). In one embodiment, the processing circuitry 504 may comprise circuitry configured to execute provided programming. For example, the processing circuitry 504 may be implemented as a microprocessor or other structure configured to execute executable instructions of programming including, for example, software and/or firmware instructions. Other exemplary embodiments of processing circuitry 504 include hardware logic, PGA, FPGA, ASIC, and/or other structures. These examples of the processing circuitry 504 are for illustration and other configurations are possible for implementing operations discussed herein.

In another embodiment, the processing circuitry 504 is configured to register users authorized to send print requests to select printers that are communicatively coupled to communications network (e.g., 210, 1210, 2210) in accordance with various embodiments of the invention. Information regarding such registered users may be stored in a storage device 508 of the print server 208. Users identified in a list stored in the storage device 508 may be considered as registered users of a select printer among a plurality of printers (e.g., 202, 204, 206, or 302, 304, 306), while those users that are absent from the list are considered as unregistered users of such printers.

The print server 208 includes the storage device 506 configured to store electronic data, file systems having one or more electronic files, programming such as executable instructions (e.g., software and/or firmware), and/or other digital information and may include processor-usable media. Processor-usable media includes any article of manufacture that can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, and infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

The storage device 208 includes a database 508 that may be stored with information for performing translation from one communication link format or technological link format to another. For example, the database 508 may include information for converting a print request received from external devices (e.g., 214, 216) into a communication link format that is compatible with printers 202, 204, 206 that are communicatively coupled to the communications network 210, or printers 302, 304, and 306 that are communicatively coupled to the communications network 1210.

The print server 208 may be configured to implement such features as, for example, accounting, authentication, and authorization functions. The print server 208 may also be configured to keep track of the print requests received from external devices 214, 216 (FIG. 2) and the print requests that are processed by printers 202, 204, 206 (FIG. 2). Authentication and authorization functions may be implemented in the print server 208 to selectively provide access to print requests received from external devices 214, 216. For example, the print server 208 may be programmed with features to screen the print requests from external devices 214, 216 and permit further processing (e.g., translation and forwarding of print requests to printers) of only such requests from external devices having proper authorization. In the event the print server 208 receives a print request from an unauthorized external device, then such requests may be discarded by the print server 208 without processing (e.g., translation, forwarding, printing) of requested tasks. Further, select devices among external devices 214, 216 may be authorized to print on select printers among printers 202, 204, and 206. For example, the external device 214 may be authorized to print only on the printer 202, and the external device 216 may be authorized to print only on the printers 204 and 206, but not on the printer 202. Similarly, any number of authorization combinations may be implemented in the print server 208.

The print server 208 may also be configured to implement such bridge functions as, for example, J2EE (Java 2 Enterprise Edition), UPnP, and .NET. J2EE technology and its component based model simplifies enterprise development and deployment, manages server infrastructure and supports web services between external devices 214, 216 and the print server 208.

UPnP architecture leverages TCP/IP and web technologies to enable seamless proximity networking between divergent communication networks (e.g., communication networks 210, 212) in addition to control and data transfer among such communication networks.

The above described authentication and authorization functions may be equally implemented in print servers 1208 and 2208, respectively, shown in FIGS. 3-4, in accordance with various embodiments of the invention.

FIG. 6 is an exemplary detailed schematic of the print server 208 in accordance with various embodiments of the invention. The print server 208 includes a processing circuitry 504, a volatile memory 604 (e.g., synchronous dynamic random access memory (SDRAM)), a non-volatile memory 606 (e.g., flash memory), physical layer components 608, 609, status indicators 610.

The processing circuitry 504 includes a controller 612 (e.g., an SDRAM controller), another controller 614 (e.g., a flash memory controller), an embedded central processing unit (CPU) 616, and link layer media access controllers (MAC) 618, 620. In the exemplary embodiment of FIG. 6, the processing circuitry 504 is configured as an ASIC. Other ways of configuring a print server having a processing circuitry are possible.

The memory 604 is configured to store data for operation of print server (e.g., 208) as well as buffering print data as it flows through the print server 208 in accordance with various embodiments of the invention.

The physical layer components 608, 609 may be individually configured to link communication formats of the respective link layer MAC's 618, 620. The print server 208 is configured to receive external data via physical layer of one network (e.g., communication network 212), process the received data, and then transmit the processed data over another physical layer to another network (e.g., communication network 210).

The status indicators 610 may be configured to provide an indication of status of the plurality of printers (e.g., 202, 204, 206 or 302, 304, 306) in accordance with various embodiments.

In one case, CPU 616 may be configured to control various functions of the print server 208. The memory 606 includes native firmware circuitry to perform translation functions, as described above, in accordance with various embodiments of the invention. The firmware may be created using an application program to implement interfaces between various components of the print server system 200 (FIG. 2). Such firmware code includes, for example, higher layer network protocols, bridge logic to flow from one communication network to another communication network, and services for obtaining various functionalities (e.g., translation of formats, forwarding of print requests, etc.) of the print server 208 described as above in accordance with various embodiments of the invention.

Individual MACs 618, 620 may be configured to provide link layer access for similar or different communication or technological links (e.g., 210, 212). Examples of such communication or technological links include WLAN, WPAN, WMAN, PAN, LAN, including Ethernet, any version of IEEE 802.11, and Bluetooth communication technologies.

Referring to FIG. 7, an exemplary methodology illustrating operations of the print server 208 of the print server system 200 is shown. Other methods are possible including more, less or alternative steps.

At a step 702, the communication networks (e.g., 210, 212) are communicatively coupled to the print server (e.g., 208, 1208, and 2208). The process then proceeds to step 704.

At a step 704, the print server is communicatively linked to printers, (e.g., (202, 204, 206) or (302, 304, and 306)) via the communications network 210. The process then proceeds to step 706.

At a step 706, the print server is communicatively linked to external devices (e.g., 214, 216) via the communications network (e.g., 212). The process then proceeds to step 708.

At a step 708, a print request from the external devices is translated or converted from one communication link format or technological link format as understood by the external devices coupled to the communication network 212 into another communication link format or technological link format as understood by the printers coupled to the communications network 210. The process then proceeds to step 710.

At a step 710, the print server informs the external devices about the printers it supports.

Exemplary advantages of various aspects of the invention include (i) leveraging the existing network of printers to a new link technology without a need to upgrade individual printers with a new print server, (ii) providing additional functionality or services to the new print server, (iii) enabling traditional print servers to be simpler, less complex, and utilize less expensive technology, (iv) the new print server may be configured to act as a proxy to external services that could provide new functionality that has not yet been implemented by the new print server. The new print server may be configured to have protocols that automatically forward requests that are not understood by the new print server to external services configured to fulfill the requests.

The protection sought is not to be limited to the disclosed embodiments, which are given by way of example only, but instead is to be limited only by the scope of the appended claims.

1. A hard copy imaging system, comprising:
a first communications network configured to operate in a first communication link format;
a second communications network configured to operate in a second communication link format;
a plurality of hard imaging devices communicatively coupled to the first communications network;
an external device communicatively coupled to the second communications network, the external device being configured to forward a print request to at least one of the plurality of hard imaging devices for processing; and
a print server communicatively coupled to the plurality of hard imaging devices via the first communications network and to the external device via the second communications, network, the print server being configured to receive the print request from the external device in the second communication link format and automatically generate a translated print request in the first communication link format for processing by at least one of the plurality of hard imaging devices, the print server being further configured to automatically generate and communicate a signal to the external device, the signal being indicative of individual hard imaging devices among the plurality of hard imaging devices configured to be supported by the print server even if the plurality of hard imaging devices are not configured to support the second communication link format.

2. The system of claim 1, wherein a user of the external device being enabled to identify the individual hard imaging devices to service the print request generated in the second communication format and sent via the print server, and wherein the first and second communication link formats are configured to have similar communication link formats but with differing communication protocol layers.

3. The system of claim 1, wherein the first communications network is a local area network (LAN).

4. The system of claim 1, wherein the second communications network comprises one of a wired network or a wireless network.

5. The system of claim 1, wherein the print server is configured to support multiple discovery techniques including Bluetooth service discovery protocol, and Universal Plug and Play Service Discovery protocol.

6. The system of claim 1, wherein the print server is configured to advertise to the external device that the print server supports a plurality of communication protocols and standards even if the individual hard imaging devices of the plurality of hard imaging devices are not configured to support the plurality of communication protocols and the standards.

7. The system of claim 1, wherein the print server is configured to incorporate security features to only permit a user of the external device to forward a print request to individual ones of the plurality of hard imaging devices having the security features.

8. The system of claim 1, wherein the print server is configured to support a plurality of communication protocols and operating systems.

9. The system of claim 8, wherein the print server comprises:
a communications interface configured to communicate with the first and second communications networks;
a storage device configured to store information related to the hard imaging devices and instructions to process print requests received from the external device; and
processing circuitry configured to communicate with the external device and individual ones of the plurality of hard imaging devices, wherein communication with the external device being performed using the second communication link format and communication with the individual ones of the plurality of hard imaging devices being performed using the first communication link format.

10. The system of claim 9, wherein the processing circuitry of the print server comprising:
a first memory device configured to store data for operation of the print server;
a second memory device configured to store firmware data;
status indicator devices configured to provide an indication of status of the hard imaging devices; and
a plurality of physical layer components configured to convert print requests in the second communication link format to the first communication link format.

11. The system of claim 10, wherein print requests from the external device are received via the second communication network by one of the physical layer components, processed by the processing circuitry, and transmitted to the first communication network via another of the physical layer components.

12. The system of claim 10, wherein the processing circuitry further comprises:
a plurality of media access controllers (MAC), individual MACs being configured to provide link access to a specific communication protocol;
a first controller configured to control operations of the first memory device; and
a second controller configured to control operations of the second memory device.

13. The system of claim 12, wherein the processing circuitry further comprises:
information related to higher layer network protocols; and
bridge logic to enable flow of information between the first and second communication networks.

14. The system of claim 1, wherein the print server being configured to function as a proxy server to requests from the external device to provide functionalities not supported by the print server.

15. The system of claim 14, wherein the print server being configured to automatically forward requests, received from the external device, that are not understood by the print server to an external service for further processing.

16. The system of claim 1, wherein the hard imaging devices comprise a printer.

17. The system of claim 1, wherein individual ones of the plurality of hard imaging devices being configured to implement a common printing protocol, and the print server being configured to convert print requests from the external device to the common printing protocol.

18. A print server system, comprising:
first and second communication networks configured to operate in distinct communication link formats;
a plurality of printers individually configured to process print requests;
an external device communicatively coupled to the second communications network, the external device configured to generate a print request for processing by at least one of the plurality of printers;
a print server communicatively coupled to the first and second communication networks, the print server being communicatively coupled to the plurality of printers via the first communications network and to the external device via the second communications network, the print server being configured to receive a print request from the external device in a second communication link format and generate a translated print request in a first communication link format that is different from the second communication link format, the translated print request being forwarded to at least one of the plurality of printers for processing, the print server being further configured to communicate with the external device with information regarding individual printers supported by the print server even if the individual printers are incompatible to directly process a print request from the external device, and the print server being configured to function as a proxy server for requests, from the external device, to enable functions not supported by the print server.

19. The system of claim 18, the print server comprising:
a communications interface being configured to communicate with the first and second communications networks;
a storage device being configured to store information related to the plurality of printers and instructions to process print requests received from the external device; and
processing circuitry being configured to communicate with the external device and individual ones of the plurality of printers, wherein communication with the external device is performed using a second communication link format and communication with the individual ones of the plurality of printers is performed using a first communication link format that is different from the second communication link format.

20. The system of claim 19, wherein the processing circuitry of the print server comprises:
a volatile memory configured to store data for operation of the print server;
a non-volatile memory configured to store firmware data; and
a plurality of physical layer components configured to convert print requests from a communication link format to another distinct communication link format.

21. The system of claim 20, wherein print requests from the external device are received via the second communication network by one of the physical layer components, processed by the processing circuitry, and transmitted to the first communication network via another of the physical layer components.

22. The system of claim 20, wherein the processing circuitry further comprises:
a plurality of media access controllers (MAC), individual MACs being configured to provide link access to a specific communication protocol;
a first memory controller configured to control the volatile memory;
a second memory controller configured to control the non-volatile memory;
information related to higher layer network protocols; and
bridge logic to enable flow of information between the first and second communication networks.

23. The system of claim 18, wherein the print server is configured to forward requests, from the external device, that are not understood by the print server to an external service.

24. A printer server system comprising:
a printer server means for communicatively coupling distinct communication networks to enable communication therebetween;
a first communication means for communicatively linking the print server means to a plurality of printers;
a second communication means for communicatively linking the print server to an external device; and
the print server means configured for receiving a print request from the external device in a second communication link format and automatically generating a translated print request, in a first communication link format that is different from the second communication link format, the translated print request being forwarded by the printer server means for processing by at least one of the plurality of printers, the print server means being configured for automatically generating and communicating a signal to the external device, the signal being indicative of individual printers among the plurality of printers that are supported by the print server means even if the plurality of printers are not configured to support the second communication link format.

25. The print server system of claim 24, wherein the print server means being configured to support multiple discovery techniques including Bluetooth service discovery protocol and Universal Plug and Play Service Discovery protocol.

26. A print server system comprising:
a print server communicatively coupled to a plurality of printers via a first communications network and to an external device via a second communications network, the first and second communications networks being configured to operate using distinct communication link formats;
a communications interface being configured to communicate with the first and second communications networks;
a storage device being configured to store information related to the plurality of printers and instructions to process print requests received from the external device; and
processing circuitry configured to communicate with the external device and individual ones of the plurality of printers, wherein communication with the external device being performed using a second communication link format and communication with the individual ones of the plurality of printers being performed using a first communication link format that is different from the second communication link format, the processing circuitry including:
a volatile memory configured to store data for operation of the print server;
a non-volatile memory configured to store firmware data;
a plurality of physical layer components configured to convert print requests from a communication link format to another distinct communication link format; and
the print server being configured to receive a print request from the external device in the second communication link format and generate a translated print request in the first communication link format, the translated print request being forwarded to at least one of the plurality of printers for processing.

27. The print server system of claim 26, wherein the print server being further configured to communicate with the external device with information regarding individual printers, supported by the print server even if the individual printers are incompatible to directly process a print request from the external device; and
further wherein the print server being configured to function as a proxy server for requests, from the external device, to enable functions not supported by the print server.

28. A method enabling communication between distinct communication networks operating in distinct communication link formats, the method comprising:
communicatively coupling the distinct communication networks to a print server to enable communication therebetween via the print server;
communicatively linking the print server to a plurality of printers via a first communication network among the distinct communication networks;
communicatively linking the print server to an external device via a second communication network among the distinct communication networks;
configuring the print server to receive a print request from the external device in a second communication link format and generate a translated print request, in a first communication link format that is different from the second communication link format, for processing by at least one of the plurality of printers; and
configuring the print server to generate and communicate a signal to the external device, the signal including information of individual printers, among the plurality of printers, supported by the print server even if the plurality of hard printers are not configured to support the second communication link format.

29. The method of claim 28, further comprising enabling a user of the external device to identify the individual printers for servicing the print request generated in the second communication link format, wherein the print request is sent via the print server.

30. The method of claim 29, further comprising:
configuring the first communications network as a local area network; and
configuring the second communications network as a wireless network configured to operate using a protocol selected from the group consisting of a Bluetooth protocol, a 802.11 communication protocol, and a 802.11b communication protocol.

31. The method of claim 28, further comprising:
configuring the print server to support multiple discovery techniques including Bluetooth service discovery protocol, and universal plug and play service discovery protocol; and
configuring the print server to advertise to the external device that the print server supports a plurality of communication protocols and standards even if the individual hard imaging devices of the plurality of hard imaging devices are not configured to support the plurality of communication protocols and the standards.

32. The method of claim 31, further comprising:
receiving print requests from the external device via the second communication network by one of a plurality of physical layer components of the print server;
processing the received print requests by a processing circuitry of the print server;
transmitting the processed print requests to the second communication network via another of the physical layer components; and
configuring the print server to function as a proxy server to requests from the external device to provide functionalities not supported by the print server.

33. The method of claim 32, further comprising automatically forwarding requests from the external device, that are not understood by the print server, to an external service for further processing.

34. An article of manufacture, comprising:
processor-usable media comprising programming configured to cause a print server apparatus of a print server system to:
receive a print request from an external device in a second communication link format;
generate a translated print request in a first communication link format that is different from the second communication link format for processing by individual ones of a plurality of printers; and
generate and communicate a signal to the external device, the signal being indicative of the individual printers supported by the print server even if the plurality of hard imaging devices are not configured to support the second communication link format.

35. The article of manufacture of claim 34, wherein the programming comprises programming configured to enable the print server advertise to the external device that the print server is configured to support a plurality of communication protocols and standards even if the individual printers are not configured to support the plurality of communication protocols and the standards.
